(19) United States
(12) Patent Application Publication
(10) Pub. No.: US 2015/0053355 A1
(43) Pub. Date: Feb. 26, 2015

(54) MOBILE BEAD BREAKER TOOL

(71) Applicant: Lyle Seabrook, Red Deer (CA)

(72) Inventor: Lyle Seabrook, Red Deer (CA)

(21) Appl. No.: 14/224,028

(22) Filed: Mar. 24, 2014

Related U.S. Application Data
(60) Provisional application No. 61/886,285, filed on Oct. 3, 2013.
(60) Provisional application No. 61/804,607, filed on Mar. 22, 2013.

(51) Int. Cl. B60C 25/14

(52) U.S. Cl. CPC B60C 25/14
USPC 157/1.22

(57) ABSTRACT

A mobile bead breaking device (for separating a tire bead from a rim) comprises a cylindrical body, a bead seat engaging base lock with a plurality of bead seat engaging surfaces, stepped at each surface for full paired connection with an abutting face of the bead seat band; a rim flange engaging foot, a base lock tightener and a power transmission source within the body to i) vertically slide the base lock into removable connection with the plurality of bead seat engaging surfaces and to slide the foot into engagement with the rim; ii) horizontally slide the foot to disengage the rim from the tire bead.

### FIELD OF THE INVENTION

The present invention relates to the field tire tools and more specifically to tools for breaking of a tire bead of a mounted tire from a rim.

### BACKGROUND ON THE INVENTION

The tire bead is the inner edge of the tire that contacts the wheel flange and presses against the bead seat. The bead seals against air loss in tubeless tires and grips the wheel rim for transmitting various loads such as steering, traction, and braking. Tire bead failure can cause loss of air pressure in the tire as well as detachment of the tire from the wheel or rim.

The tire bead is a structure composed generally of high tensile strength steel wire formed into hoops that function as anchors for the tire plies (layers) that hold the tire assembly onto the rim of the wheel. Most tire beads consist of steel (piano-type) wires in parallel in a continuous rubber tape or ribbon, which loosely secures the wires in a soft insulating rubber. The ribbon is wound into a hoop, commonly made of five courses. The end result is a grommet composed of a bundle or stack of wires.

In order to remove a tire from a wheel, the tire bead must be “broken.” Bead breaking devices, to accomplish this “breaking” have taken on many forms due to the variety of tire and rim combinations being used. Most early bead breakers were used on tube type tires as the invention of the tubeless tire came much later. These bead breakers ranged in construction from simple leverage devices to screw driven mechanisms to more recently hydraulically or pneumatically driven devices. The principles of bead breaking have always been the same, no matter what form they may have taken in regard to their construction. The principle of forcing the bead away from the rim was a key in the operation of these devices. With the advent of tubeless tires the construction of rims and tires changed in a way significant enough to warrant new devices for bead breaker construction.

These challenges presented themselves in the multitude of shapes and forms that the impingement elements of a bead breaker might need to take in order to properly and effectively engage with the tire rim and bead. A further challenge was the need for greater driving forces to effectively displace the new bead forms away and free of the new rim forms. In order to achieve these greater driving forces, more robust and durable drive elements were required. Challenges were also found in the method of engaging the bead breaking shapes and forms through leverage, centrifugal, or linear force. And finally, challenges in the method of first engaging the rim and secondly striping the bead free of the rim in two distinct stages.

There are certainly devices known and used for breaking the bead, however, none of them serves to treat all of these challenges in a satisfactory way. Some of these prior devices have an abundance of power using either pneumatic or hydraulic drive elements but they lack either robust construction or they fail to accomplish this task with two distinctly independent elements, first engaging the rim, and secondly striping the bead. Others of the prior devices may use centrifugal force, linear forces, or leverage forces but never an effective combination of all three. Lastly, the prior art devices require tools for in situ use, making them less than ideal as portable or mobile devices.

There are a range of these prior devices. In most cases, the devices are either large, stationary constructions or very small hand held tools (for example, for use on bicycles and motorcycles). There also exist specialized bead breakers for use with tires from particular modes of transportation. For instance, aircraft tires, which come in a variety of sizes, generally require specialized bead breakers. Heavy machinery and trucks also require particularly durable devices.

The use of bead breakers which are not appropriate to the task poses a significant threat of damage to either the tire and/or the rim also poses dangers to the mechanics.

It is, therefore, desirable to provide a lightweight, easily transportable bead breaking device capable of quickly, effectively and accurately acting upon a tire/rim assembly. Such apparatus should be able to break the bead of a tire without further damage to either the tire or its rim and should be capable of operating under field conditions and servicing a number of different sizes and types of heavy-duty, industrial tires.

It is an object of the present invention to obviate or mitigate the above disadvantages.

### SUMMARY OF THE INVENTION

The present invention recognizes and addresses all of the foregoing limitations and drawbacks, and others, concerning a mobile bead breaking device for separating a tire from its rim or wheel. Therefore, the present invention is directed to such a device.

It is a principle object of the subject invention to provide a bead breaking device. More particularly, it is an object of the present invention to provide a lightweight and easily transportable bead breaking device which under field conditions serves a number of different sizes and types of heavy-duty, industrial tires in a quick, efficient and safe manner. In such context, it is still a more particular object of the present invention to provide such a device specifically designed to handle bead breaking for giant hauler and loader tire size.

Still further, it is a principle object of this invention to provide a bead breaking device capable of acting upon a number of different sizes and types of giant hauler and loader tires. It is a further object of the present invention to provide a bead breaking device suitable for field deployment without additional tools and support equipment. In such context, it is an object of the present invention to provide a pneumatic tire bead breaker.

Additional objects and advantages of the invention are set forth in, or will be apparent to those of ordinary skill in the art, from the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

In one exemplary embodiment, there may be provided a mobile hydraulic or pneumatic tire bead breaker. Such bead breaking device may be adjustable to service a wide range of tire sizes. Additionally, it may be self-contained and relatively lightweight with a compact form making it particularly suitable for deployment to remote work sites. Further, it may primarily comprise simple components that are easily replaceable or repairable thus ensuring its ease of maintenance and reliability.

The present invention provides a mobile bead breaking device (for separating a tire bead from a rim) which comprises a cylindrical body, a bead seat engaging base lock with a plurality of bead seat engaging surfaces, stepped at each surface for full paired connection with an abutting face of the bead seat band; a rim flange engaging foot, a base lock tightener and a power transmission source within the body to i) vertically slide the base lock into removable connection with the plurality of bead seat engaging surfaces and to slide the foot into engagement with the rim; ii) horizontally slide the foot to disengage the rim from the tire bead.

The present invention further provides a method of separating a tire bead from a rim (comprising a bead seat band) which comprises engaging base lock with a plurality of bead seat engaging surfaces, wherein the base lock is stepped at each bead seat engaging surface for full paired connection with a respective abutting face of the bead seat band; engaging a foot with a rim flange, tightening the base locker to secure connection to each surface of the bead seat band, vertically sliding the base lock into removable connection with the plurality of bead seat engaging surfaces, sliding the foot into engagement with the rim; and horizontally sliding the foot to disengage the rim from the tire bead.

There are numerous and specific advantages of this device as compared to other known and used bead breaking apparatus. Of key importance is the type and degree of conformation of the base lock and bead seed band (also referred to herein as “BSB”). Under pressure and in alignment, an “inner surface” of the base lock, which abuts the BSB is in full conformed contact with said BSB such that no part of the inner surface of the base lock is exposed. This provides security not found in any of the prior know bead breaking apparatus. Furthermore, the device of the present invention is simple, had few moving parts, does not require in situ tools to operate (i.e. is self-contained).

These and other objects and advantages of the present invention will become more apparent to those skilled in the art upon reviewing the description of the preferred embodiments of the invention, in conjunction with the figures.

### BRIEF DESCRIPTION OF THE DRAWINGS

The present invention will be better understood and objects apparent when consideration is given to the detailed description herein, made with reference to the annexed drawings wherein:

FIG. 1 is a side view of a bead breaking device;

FIG. 2 is a perspective exploded view of a bead breaker device;

FIG. 3 is a photograph of a bead breaking device, in perspective view;

FIG. 4 is another photograph of a bead breaking device, in perspective view;

FIG. 5 is a photograph of a bead breaking device, in engagement with a tire rim and tire bead;

FIG. 6 is another photograph of a bead breaking device, in engagement with a tire rim and tire bead;

FIG. 7 is another photograph of a bead breaking device, in engagement with a tire rim and tire bead;

FIG. 8 is another photograph of a bead breaking device, in engagement with a tire rim and tire bead;

FIG. 9 is another photograph of a bead breaking device, in engagement with a tire rim and tire bead;

FIG. 10 is another photograph of a bead breaking device, in engagement with a tire rim and tire bead;

FIG. 11 is a side view of a foot (also referred to as push pin);

FIG. 12 shows a plurality of views of a body or housing (also referred to as a cylinder mount);

FIG. 13 shows a plurality of views of a base lock;

FIG. 14 shows a plurality of view of a base lock;

FIG. 15 is a photograph of the bead breaker in situ;

FIG. 16 is a photograph of the bead breaker being positioned;

FIG. 17 is a photograph of the bead breaker being secured in place;

FIG. 18 is a photograph of the bead breaker being secured in place;

FIG. 19 is an exploded perspective view of bead breaker device wherein right and left jaws are replaceable and removably attached to channel body;

FIG. 20 is a perspective view of the non-exploded bead breaker device of FIG. 19;

FIG. 21 is another exploded perspective view of bead breaker device wherein right and left jaws are replaceable and removably attached to channel body;

FIG. 22 is a perspective view of the non-exploded bead breaker device of FIG. 21;

FIG. 23 is a perspective view of exploded perspective view of bead breaker device wherein right and left jaws are replaceable and removably attached to channel body;

FIG. 24 is a perspective view of cylinder of body with engagement holes for three screws on each side;

FIG. 25 is a perspective view of replaceable jaw, right side;

FIG. 26 is a perspective view of replaceable jaw, left side;

FIG. 27 is a perspective view of foot or push pin, 80;

FIG. 28 is a perspective view of a base lock;

FIG. 29 is a perspective view of another base lock;

FIG. 30 is a photograph of a bead breaker;

FIG. 31 is further photograph of a bead breaker;

FIG. 32 is photograph of an underside of jaw 100 and 102;

FIG. 33 is a photograph of a threaded stud knob; and

FIG. 34 is photograph of the top side of jaw 100 and 102 (alternative to FIG. 32).

### PREFERRED EMBODIMENTS OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Similar reference characters denote similar elements throughout various views depicted in the figures.

This description of preferred embodiments is to be read in connection with the accompanying drawings, which are part of the entire written description of this invention. In the description, corresponding reference numbers are used throughout to identify the same or functionally similar elements. If and when used herein relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral”, “adjacent” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

In the present disclosure and claims, the word “comprising” and its derivatives including “comprises” and “comprise” include each of the stated integers but does not exclude the inclusion of one or more further integers or elements. The terms cords and cording may be used interchangeably.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “power to actuate the device may be from a variety of sources (e.g., hydraulic cylinder within body of device), the term “e.g.” explains that “hydraulic cylinder within body of device” is an example of “a power source” by which the device operates.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains.

As used herein, a “tire bead” is the inner circle of the tire; the part of the tire that connects the tire to the rim, and holds the entire wheel together. This bead is a combination of a rubber band that is reinforced with a sturdy material such as steel cable. The rubber compound used in tire bead construction is very sturdy, and lacks flexibility. Due to this, specific machinery is necessary to properly mount tires onto a set of wheels or rims. The rubber of the bead allows for a high friction point, and an excellent grip onto the inside of the inner and outer rim, preventing the tire from sliding as the wheel rolls. Tire bead performance is crucial on the power axle, as a tremendous amount of torque works through the wheel and tire to allow the tread to “grab” the road or ground surface beneath it.

As used herein, a “bead breaker” is a device/tool used for separating tires from rims. The inside ring of the tire is generally called the lip, and the bead on the lip seals to the rim in a radial-ply tire, trapping the air inside. Often, the bead can become frozen to the rim after rusting occurs, requiring the use of a bead breaker in order to be removed.

As used herein, a “rim” is the outer edge of a wheel, holding the tire. It makes up the outer circular design of the wheel on which the inside edge of the tire is mounted on vehicles. The effective diameter of the rim is the distance between the bead seats (for the tire), as measured in the plane of the rim and through the axis of the hub which is or will be attached, or which is integral with the rim. The effective width of the rim is the separation distance between opposed rim flanges. The flange-to-flange width of a rim is generally a minimum of three-quarters of the tire section width. Generally, the maximum rim width is equal to the width of the tire thread.

The present invention provides a novel and inventive mobile bead breaking device (for separating a tire bead from a rim) from which comprises a cylindrical body, a bead seat engaging base lock with a plurality of bead seat engaging surfaces, stepped at each surface for full paired connection with an abutting face of the bead seat band; a rim flange engaging foot, a base lock tightener and a power transmission source within the body to i) vertically slide the base lock into removable connection with the plurality of bead seat engaging surfaces and to slide the foot into engagement with the rim; ii) horizontally slide the foot to disengage the rim from the tire bead.

The base lock is “stepped” in conformity with the shape of a selected BSB. Under pressure and in alignment, an “inner surface” of the base lock, which abuts the BSB is in full conformed contact with said BSB such that no part of the inner surface of the base lock is exposed. Base locks are interchangeable depending on the conformation of the BSB to ensure the requisite alignment, when the device is on place.

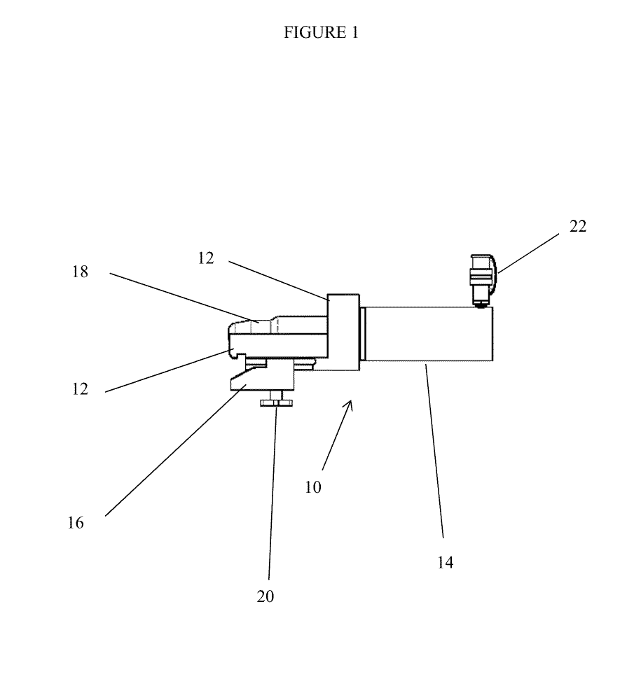

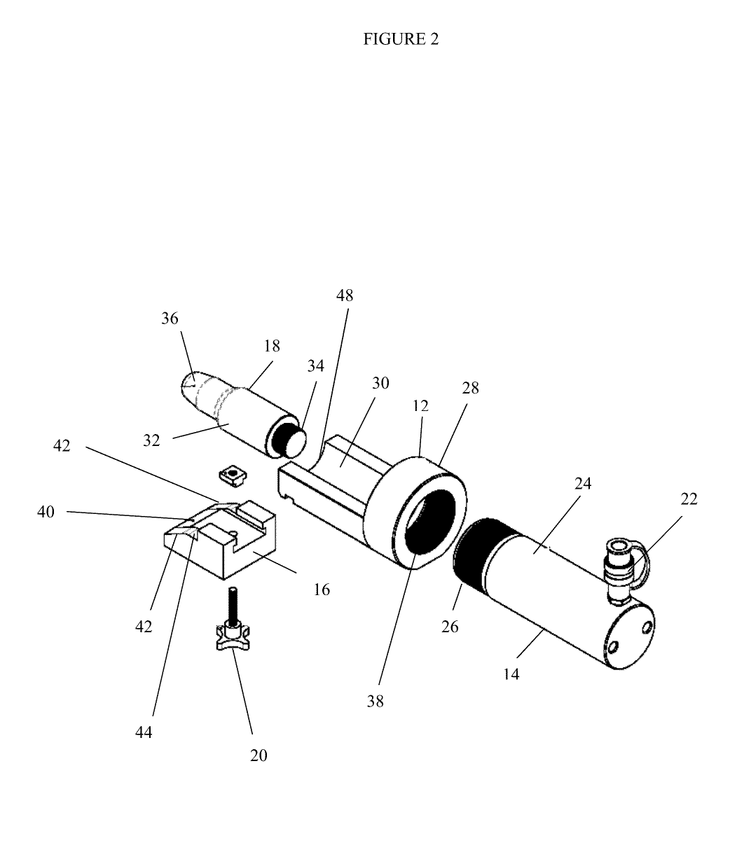

Turning now to the figures, commencing at FIG. 1: there is provided generally at 10 a bead breaking device having a cylinder mount 12, hydraulic cylinder 14, base lock 16, foot (or push pin) 18, threaded stud knob 20 and fluid connection portal 22. FIG. 2 illustrates an exploded view of these same parts with further detail as follows: cylinder mount 12, hydraulic cylinder 14, base lock 16, foot (or push pin) 18, threaded stud knob 20 (with threaded rod 21), and fluid connection portal 22. Cylinder 14 comprises drum 24 and mount threaded end 26, for engagement with annular end 28 of mount 12. Mount 12 additionally comprises body channel 30 the distal end (48) of which, in operation, further abuts and secures the position of the bead breaking device. Foot 18 comprises body 32, body threaded end 34 and, at an end which is distal from the body threaded end a rim engaging end 36 which, in a preferred form, is tapered (narrow) from body 32. In operation, body 32 slidably moves within body channel 30 from a closed position to a rim engaging position. Mount threaded end 26 engages with body threaded end 34.

Base lock 16 is a bead seat engaging base lock with a plurality of bead seat engaging surfaces, 40, 42 and 44 wherein the respective surfaces are stepped for full paired connection with an abutting face of the bead seat band. Tee nut 46 connects base lock 16 to cylinder mount 12.

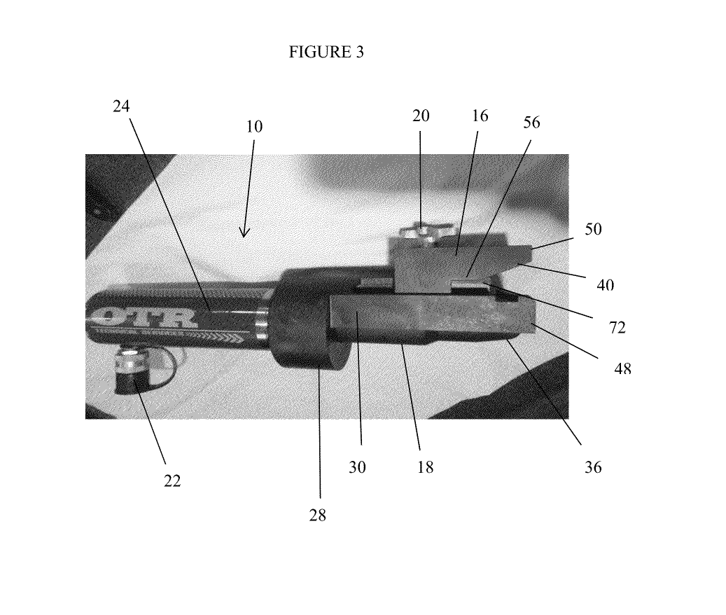

FIG. 3 is a photograph of device 10 in a non-operating (closed position) and comprises cylinder mount 12, hydraulic cylinder 14, base lock 16, foot (or push pin) 18, threaded stud knob 20, fluid connection portal 22, drum 24, body channel 30, rim engaging end 36, bead seat engaging surfaces 40, 42, 56 and 58, body channel (bead seat engaging) distal end 48.

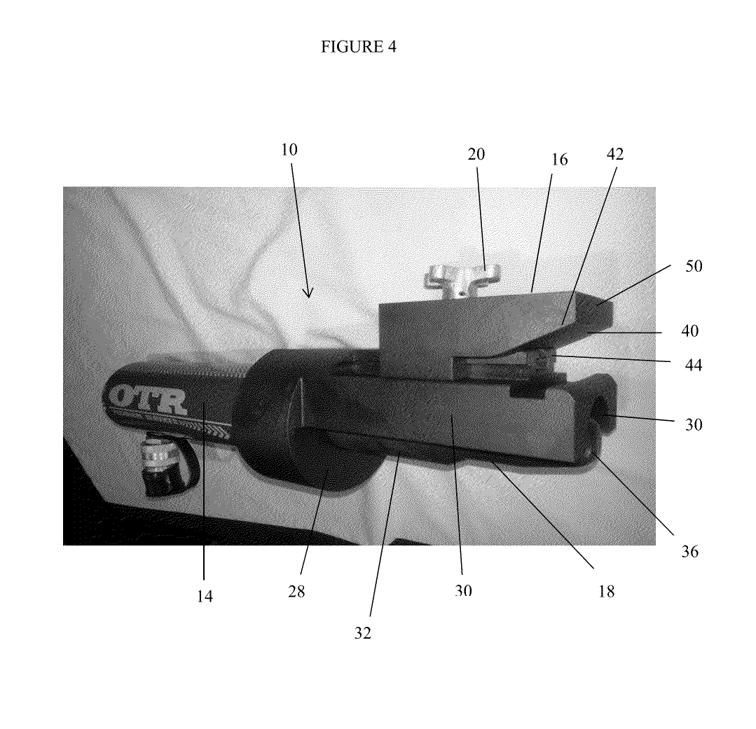

FIG. 4 provides of further photographic view of device 10 clearly showing foot 18 ensconced within channel 30 of cylinder mount 12. More specifically, there is shown:
base lock 16, and each of the bead seat engaging surfaces 40, 42, 44, 56, and 58
body threaded end a rim engaging end 36 which, in a preferred form, is tapered (narrow) from body 32 of foot 18

This plurality of “engaging surfaces” is a key feature of the device of the present invention.

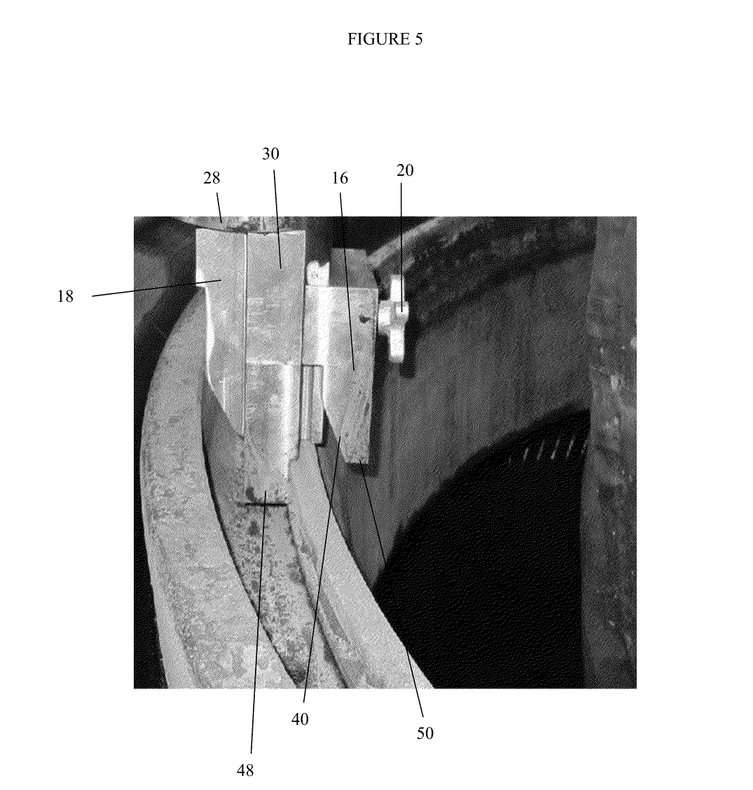

Operation of the bed breaking device is illustrated best in FIG. 5-10.

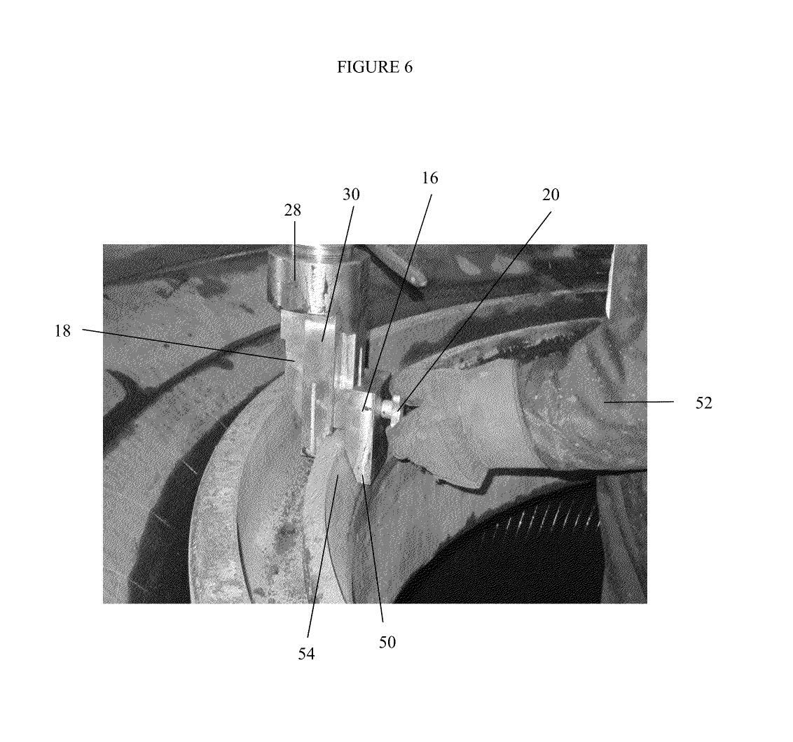

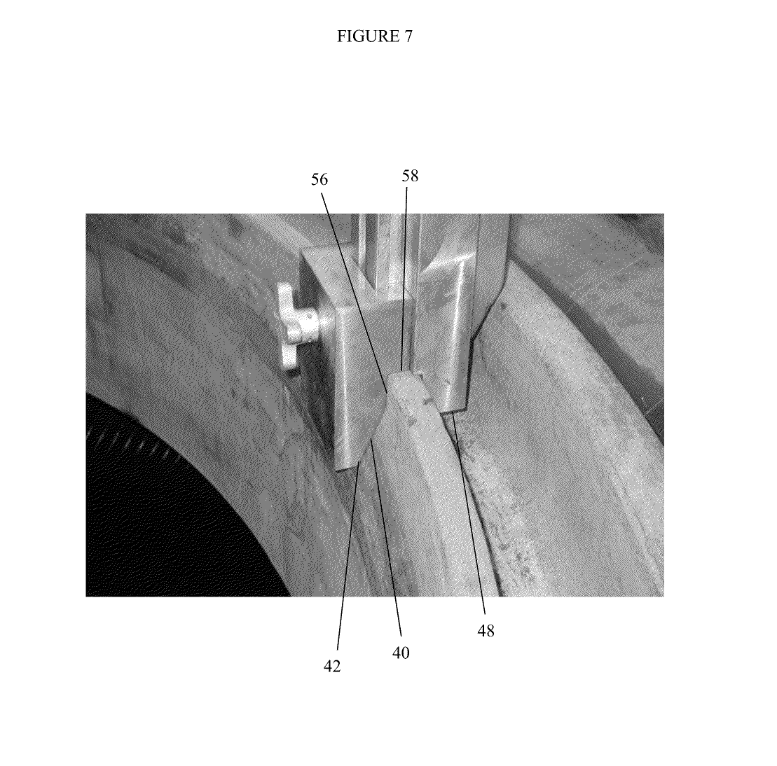

FIG. 5 shows the assembly of the being slide into the groove of the bead seat band and the threaded stud knob 20 and loosened. FIG. 6 shows a base lock 16 lowered by operator 52 into position until it makes contact with bead seat band “lock ring” area 54 and the threaded stud knob 20 is tightened by a firm amount of hands pressure. FIG. 7 shows a closer view of the device in situ, having been tightened at threaded stud knob 20 having bead seat engaging surfaces 40, 42, 44, 56 and 58 and all in respective working, secure engagement with the bead seat (lock ring contact area). Note that body channel (bead seat engaging) distal end 48 is similarly engaged in groove of seat band. The overall effect is that the combination of the base lock 16 and the channel end 48 of the body channel 30 create a jaw or clamp which securely holds the bead seat band in place while under hydraulic pressure but is yet easily and manually removable by a human operator, without any further tools.

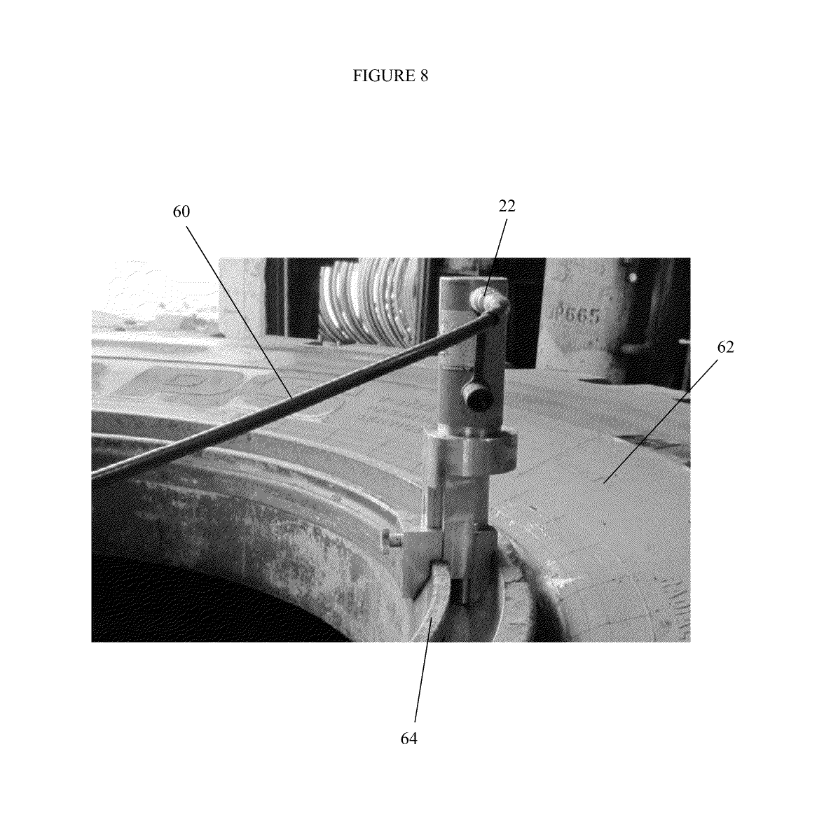

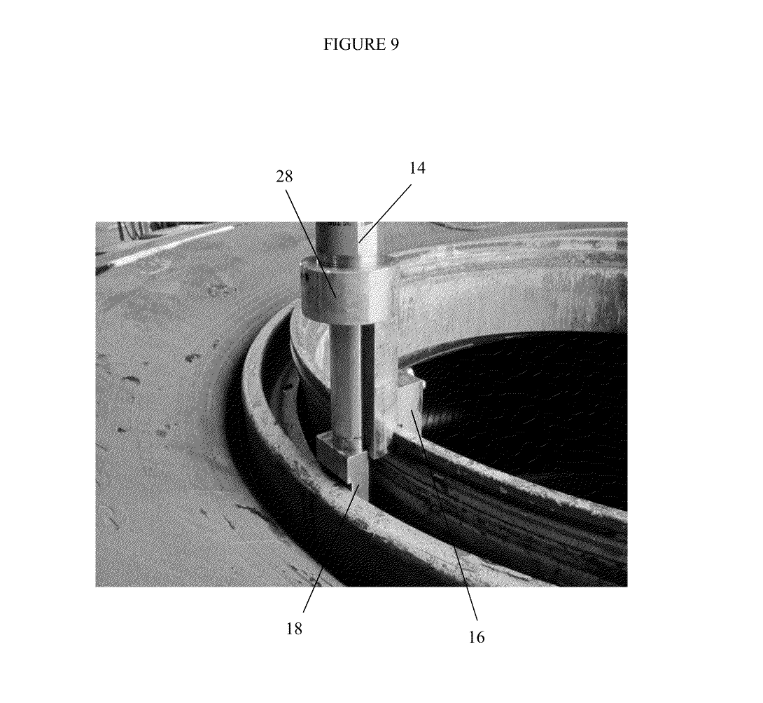

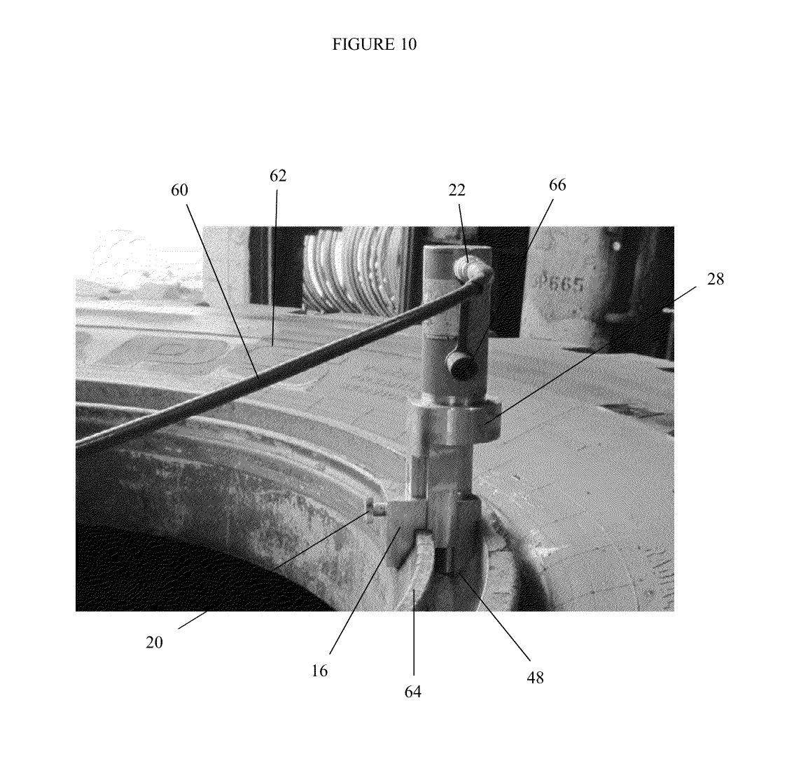

FIG. 8 shows the device of FIG. 7 in situ but additionally shows hydraulic line 60 connected to fluid connection portal 22. The device is now fully secured and ready for hydraulic pressure to be applied. Additionally, this figure best shows tire 62, bead seat band 64. FIG. 9 illustrates the application of hydraulic pressure (activation of fluid via line 60 through portal 22 to cylinder 14). The effect of this pressure activation is 1) pushing foot 18 down onto the flange and 2) separating foot 18 from base lock 16 thereby pulling bead seat band 64 from tire 62. FIG. 10 further shows that hydraulic pressure is applied until the stoke of the ram has reached approximately 4.5″. Thereafter the device is released (in part by loosening knob 20) and the operator moves the device to the right or left (approximately) 45 degrees for a subsequent “separation cycle”, as described. FIG. 10 also shows cap 66 of portal 22 hanging from connecting tab 68 (portal 22 in open position with cap 66 being replaced at the end of the task.

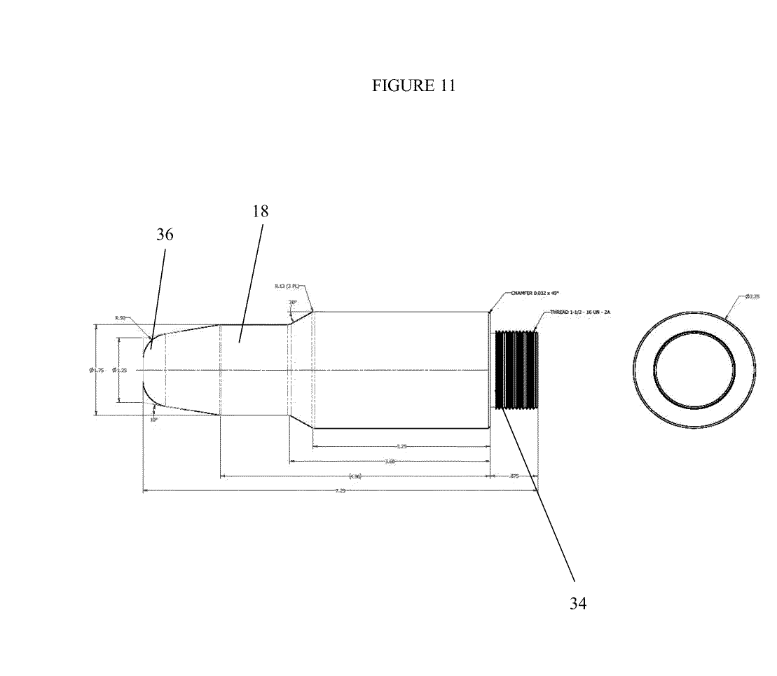

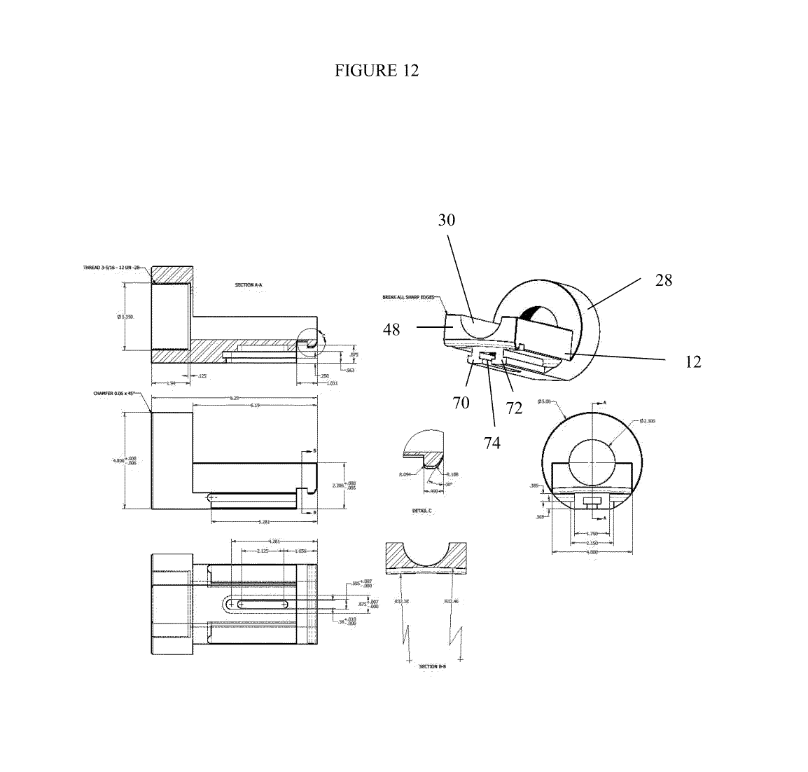

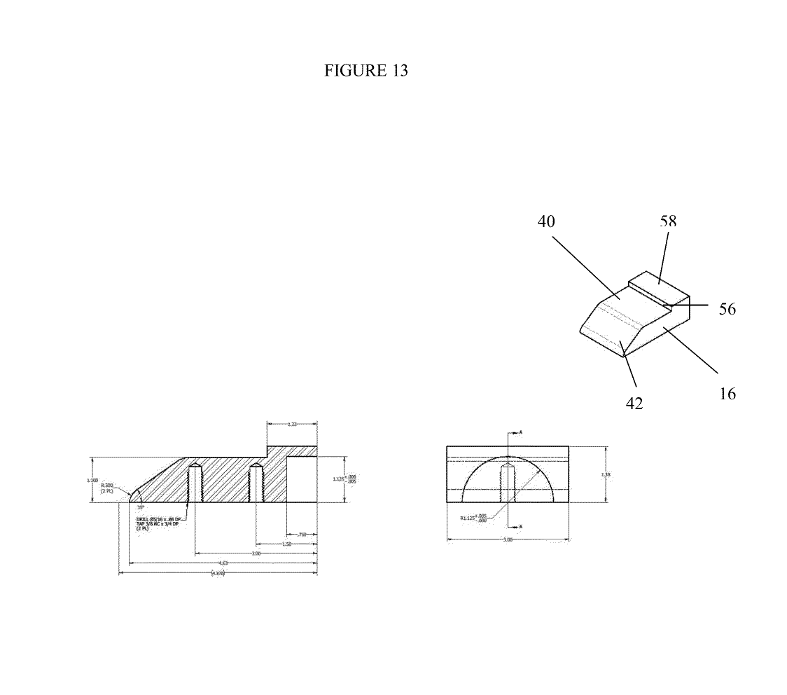

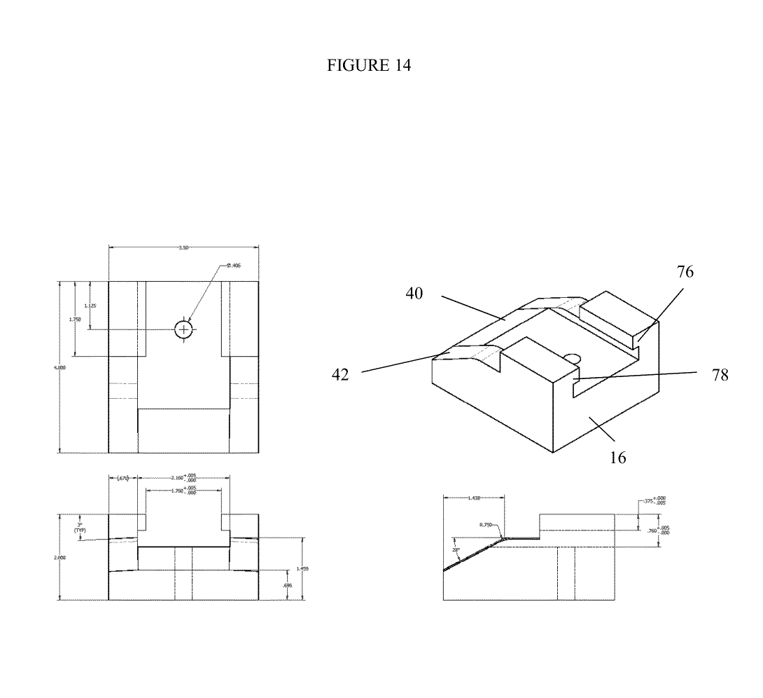

FIGS. 11-14 illustrate preferred shapes and dimensions of some key components of the device. FIG. 11 shows foot 18, with rim engaging end 36 and body threaded end 34. FIG. 12 illustrates cylinder mount 12 comprising annular end 28 and body channel 30. Also shown are protuberances 70 and 72 through which is formed there between tee nut engaging groove 74. Groove 74 serves to securably hold tee nut 46 which connects base lock 16 to cylinder mount 12. FIG. 13 illustrates base lock 16 comprising a plurality of bead seat engaging surfaces 40, 42, 56 and 58. Base lock 16 further comprises mating members 76 and 78 which slidably connect to protuberances 70 and 72, therein removably joining base lock 16 and cylinder mount 12.

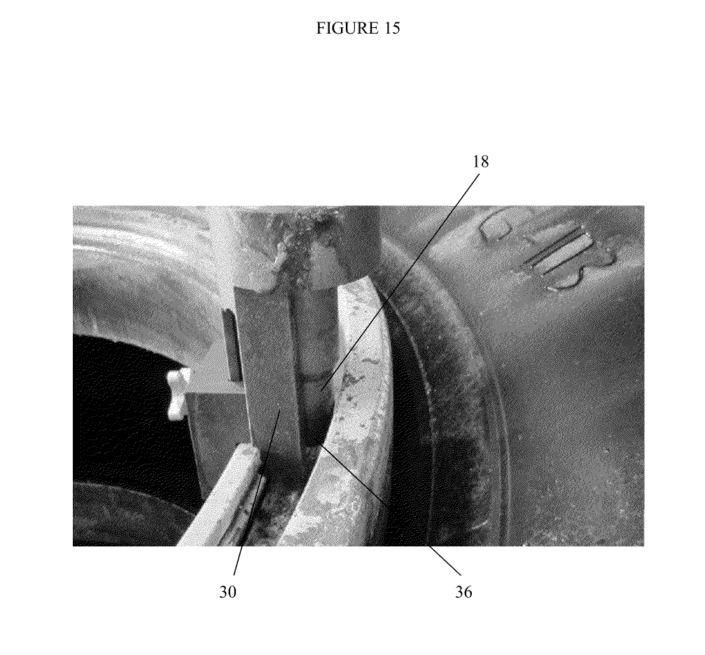

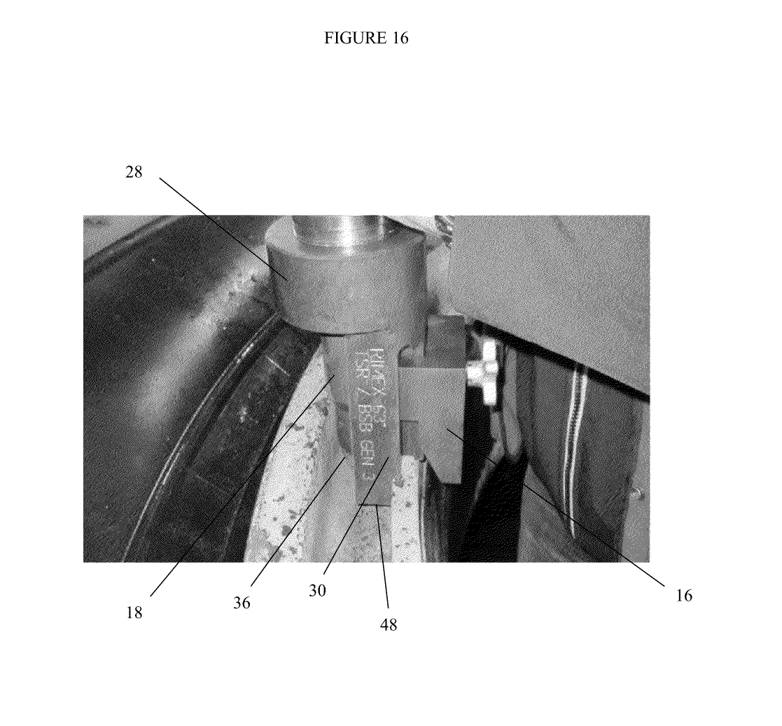

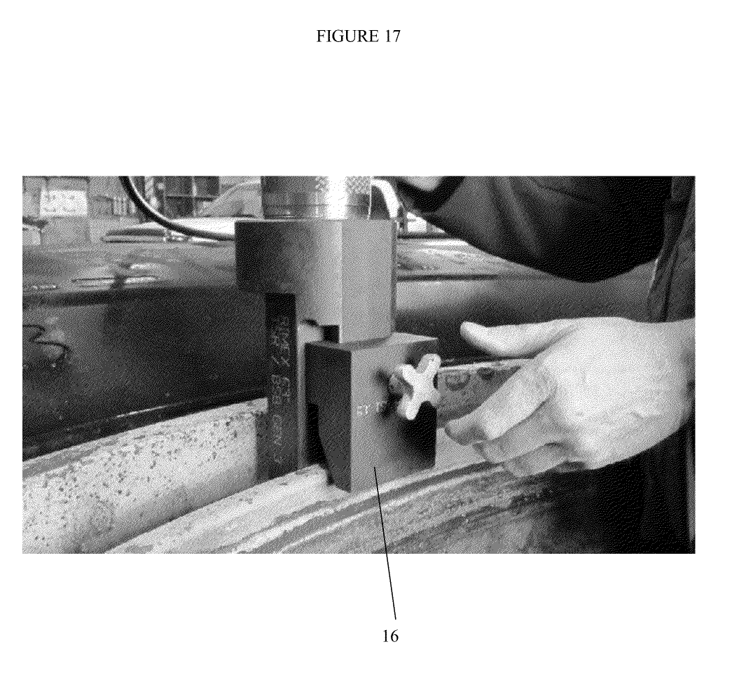

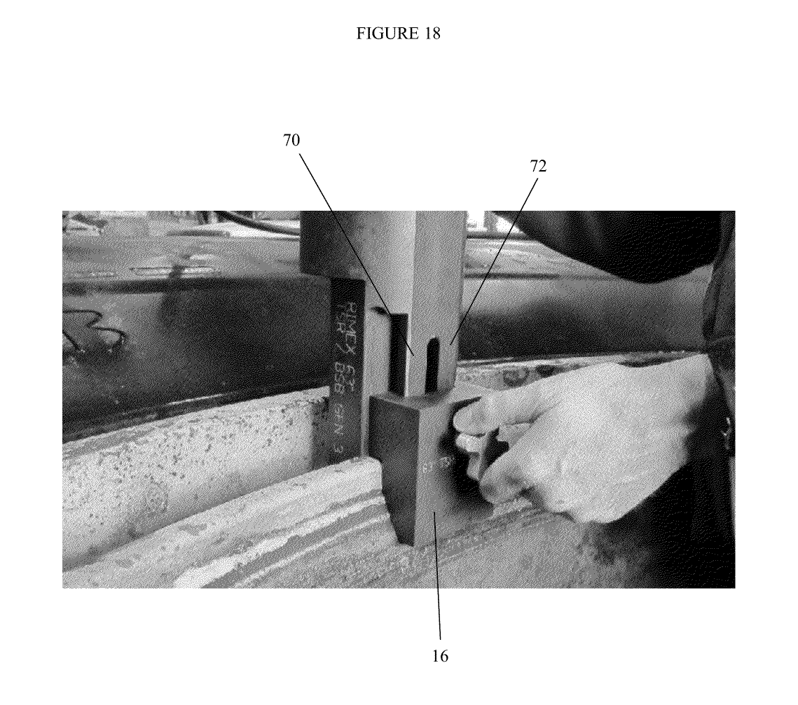

FIGS. 15-18 are photographs of device 10 during engagement. Primarily, these photographs are to further illustrate the nature and degree of contact of the bead seat engaging surfaces, the nature of such contact providing the security offered by this device as compared to prior known bead breaking devices. FIGS. 15 and 16 in particular show channel end 48 of the body channel 30 and foot 18, with rim engaging end 36. FIGS. 17 and 18 in particular show the base lock 16 and the plurality of bead seat engaging surfaces. In a preferred form, a base lock and the bead engaging surfaces will be designed for specific applications (based on size and dimensions etc. . . . ). The base lock is removable from the other components of the device and is easily interchangeable. Base lock 16 further comprises mating members 76 and 78 which slidably connect to protuberances 70 and 72 on cylinder mount 12, allowing alterations of base locks as needed.

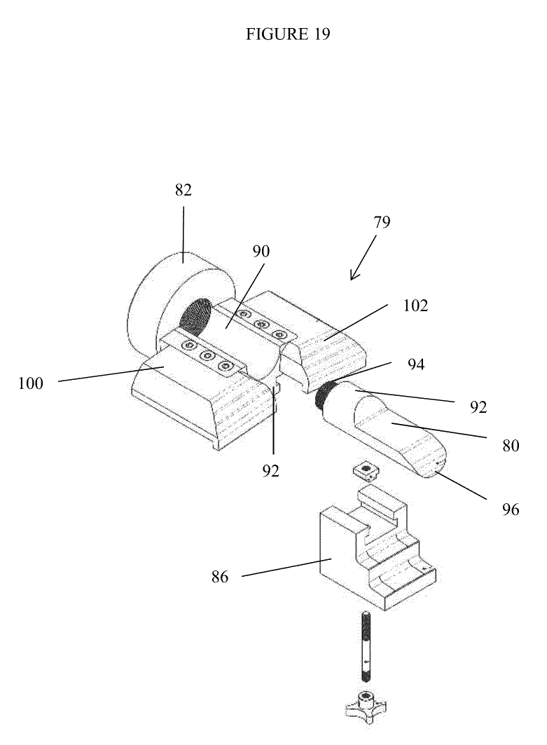

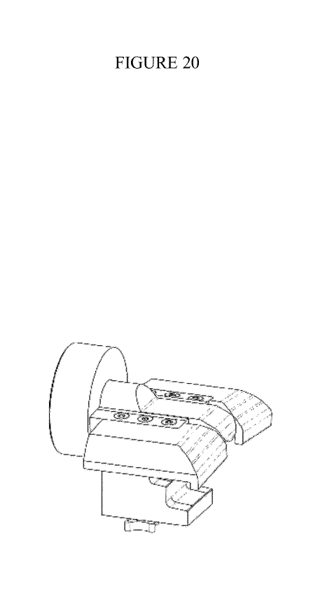

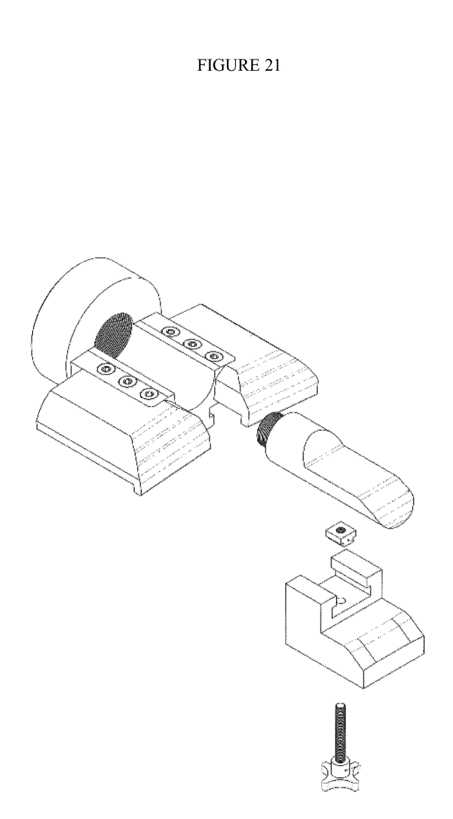

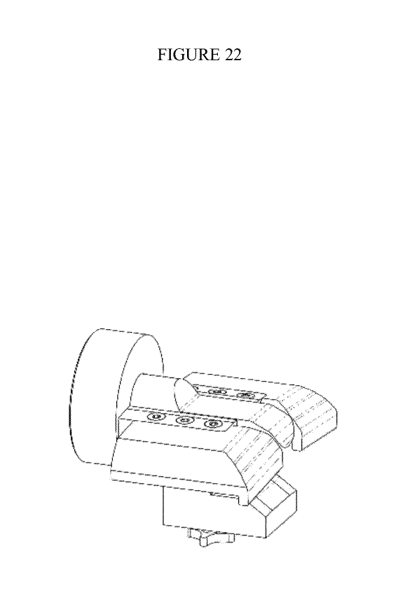

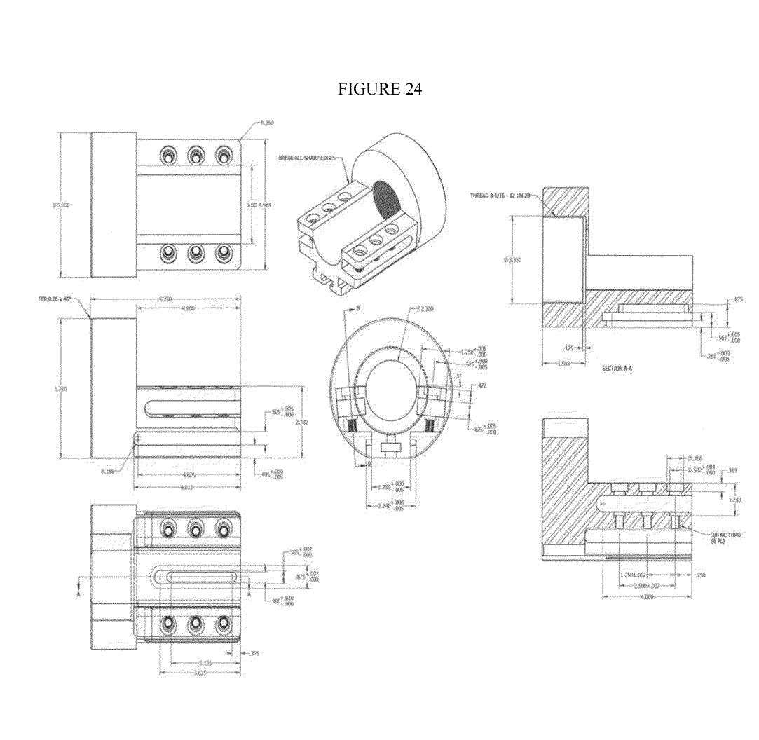

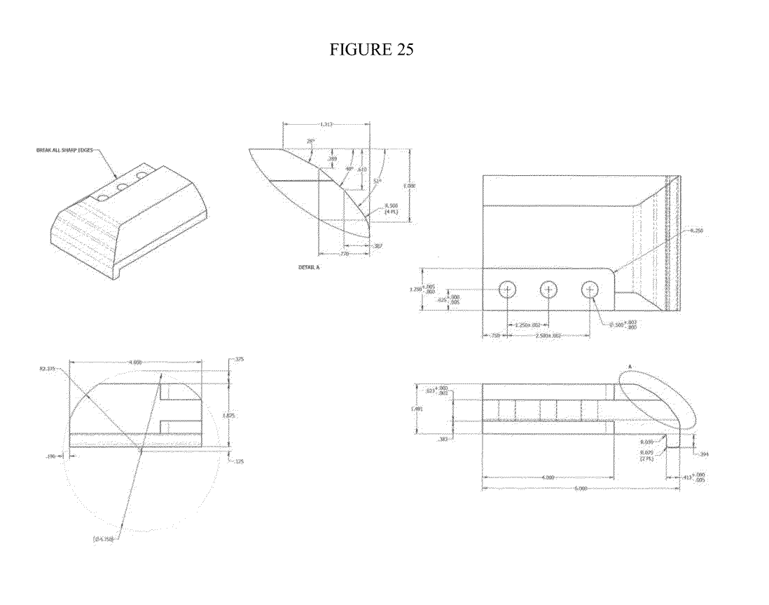

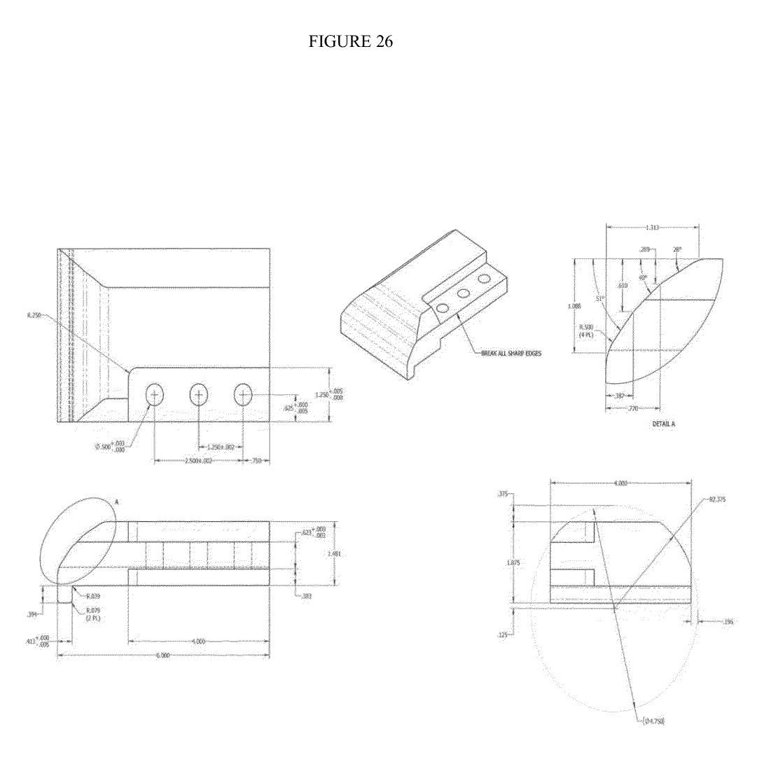

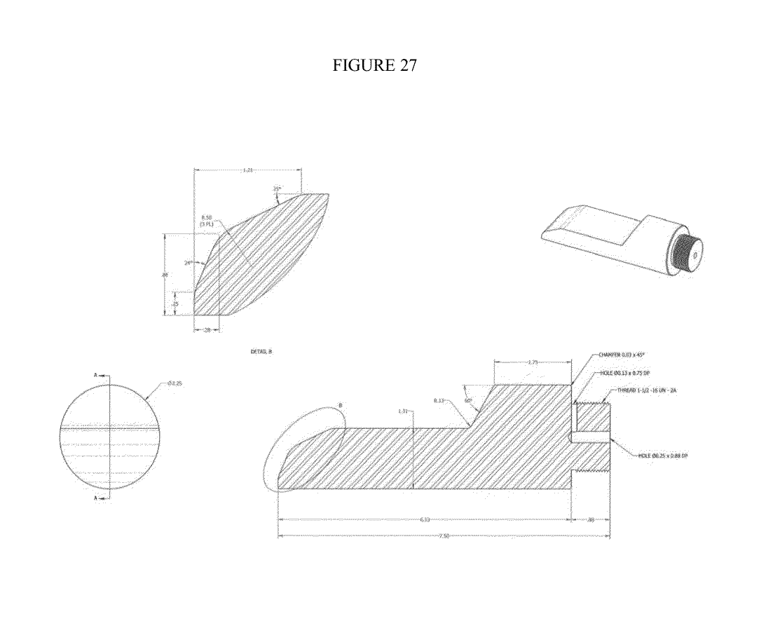

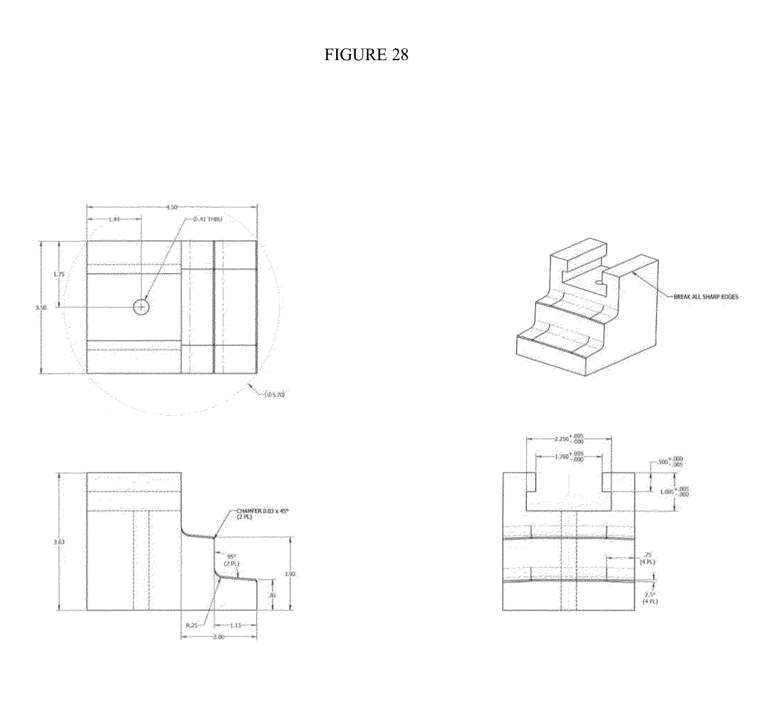

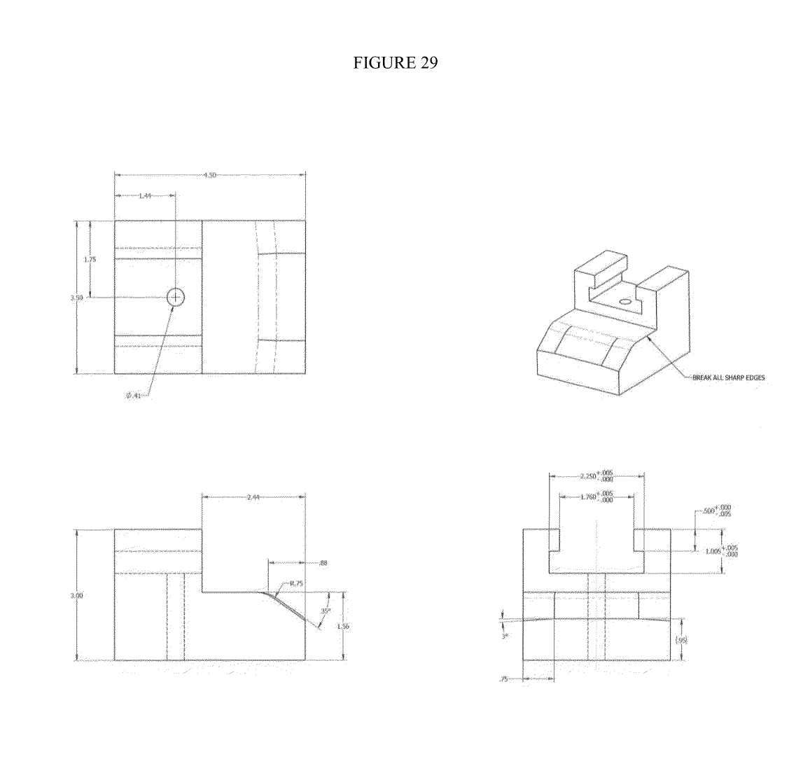

FIGS. 19-29 depict a bead breaker device wherein “left and right “jaws” are interchangeable and replaceable from the cylinder mount body. Jaw strength is important and there may be significant wear and tear on these components over continual use. Replacement of the jaws addresses this issue of component fatigue.

FIG. 19 provides generally at 79 a bead breaking device having a cylinder mount 82, base lock 86, and foot (or push pin) 80. Cylinder mount 82 additionally comprises body channel 90 the distal end (92) of which, in operation, further abuts and secures the position of the bead breaking device. Foot 80 comprises body 92, body threaded end 94 and, at an end which is distal from the body threaded end a rim engaging end 96 which, in a preferred form, is tapered (narrow) from body 92. In FIG. 19, there is a cut-out from one side of body 92 to rim engaging end 96.

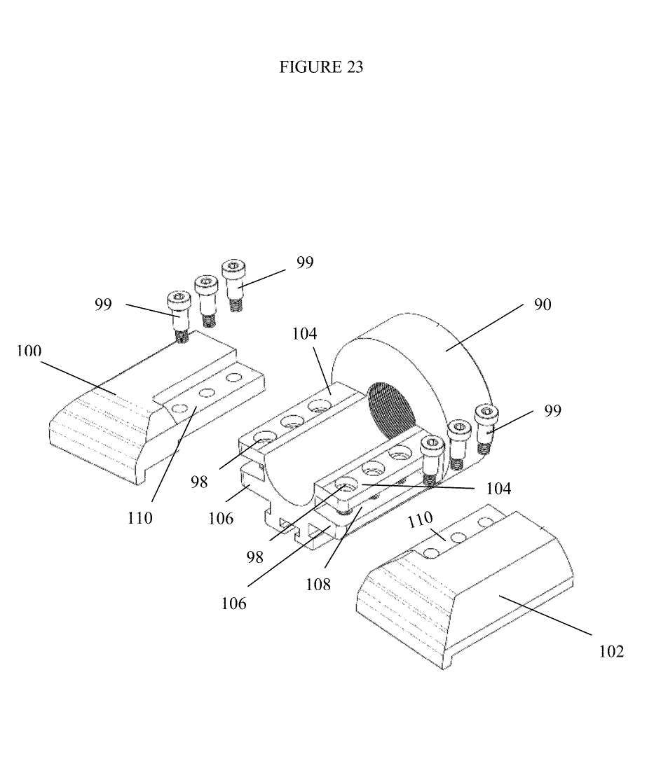

As shown best in FIG. 23, channel body 90 comprises a plurality of screw boreholes 98, for engagement of screws 99 to removably connect jaws 100 and 102 to channel body 90. More specifically, screw boreholes extend on each side of body 90 through an upper plate 104 of body 90 and an lower plate 106 of body 90. An interstitial space between upper plate 104 and lower plate 106, on each side is shown as jaw engaging channel 108.

Each of jaw 100 and jaw 102 comprises a platform 110 for slidable engagement within jaw engaging channel 108. Platform 110 comprises a plurality of screw boreholes 112 which match up to screw boreholes 98 when jaws are engaged with channel body 90. In such engagement screws 99 extend through screw boreholes 98 on upper plate 104, through screw boreholes 112, and finally through screw boreholes 98 on lower plate 106 of body 90. In this way, jaws can be attached, removed and replaced as needed.

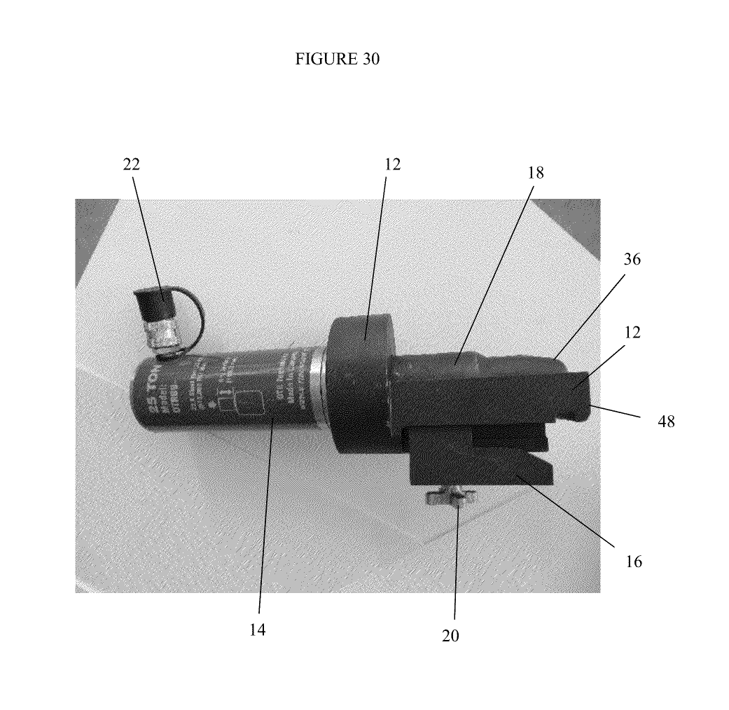

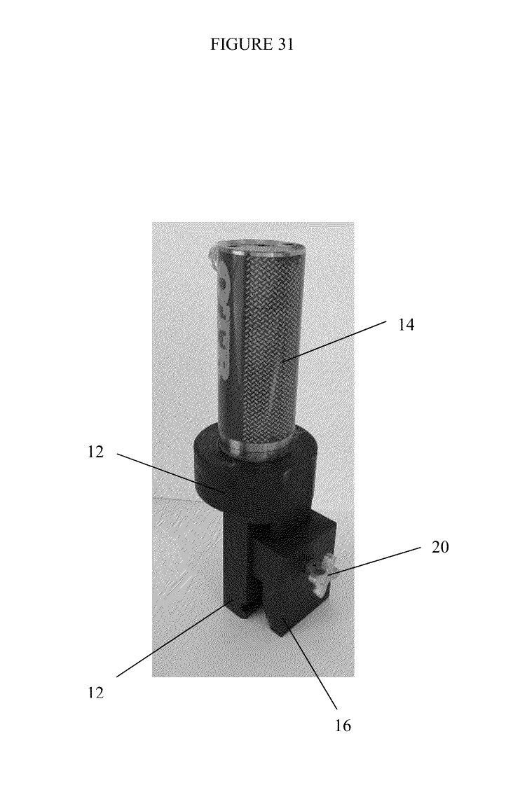

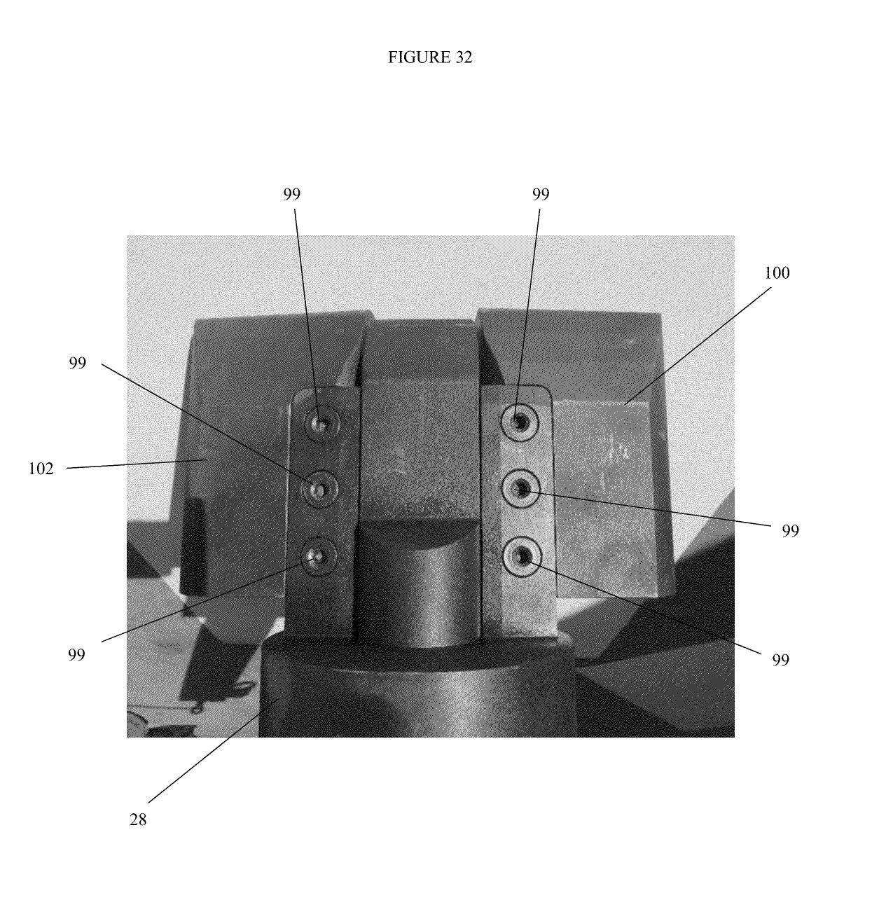

FIGS. 30 to 34 show further aspects of preferred features of the device of the invention. FIG. 30 is a photograph of a bead breaker comprising cylinder mount 12, hydraulic cylinder 14, base lock 16, foot (or push pin) 18, threaded stud knob 20, engaging end 36, and body channel (bead seat engaging) distal end 48. FIG. 31 is further photograph of a bead breaker comprising cylinder mount 12, hydraulic cylinder 14, base lock 16, and threaded stud knob 20. FIG. 32 is photograph of an underside of jaw 100 and 102 and screws 99, allowing In this way, jaws can be attached, removed and replaced as needed.

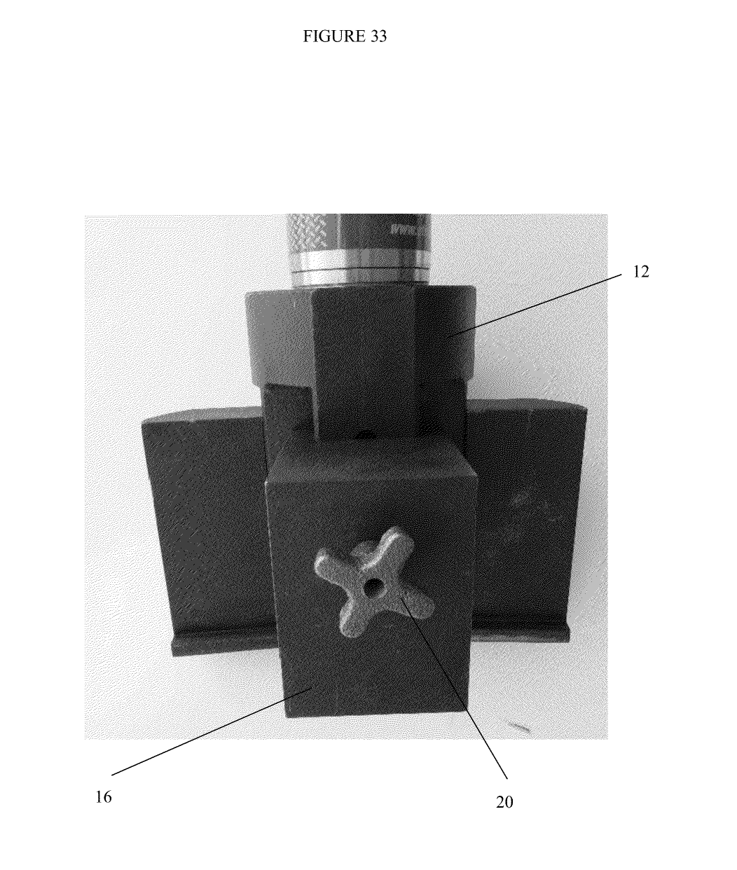

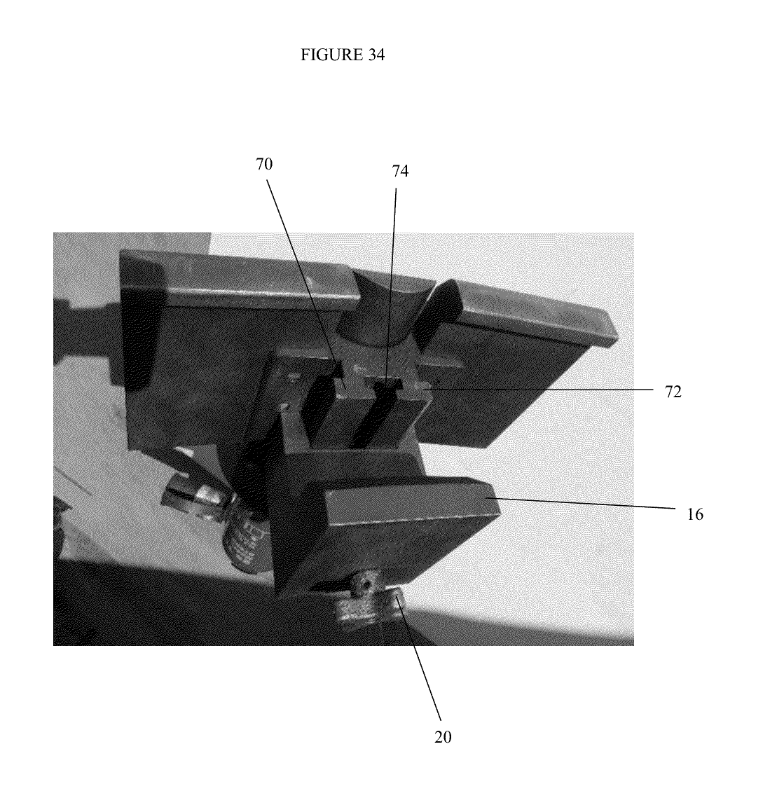

FIG. 33 is a photograph of a threaded stud knob 12. FIG. 34 is photograph of the top side of jaw 100 and 102 (alternative to FIG. 32). Base lock 16 further comprises mating members 76 and 78 which slidably connect to protuberances 70 and 72 on cylinder mount 12, allowing alterations of base locks as needed.

The present invention further provides that base locks vary in size and shape in accordance with varying wheel assemblies. Alternative base lock shapes are illustrated herein.

While the forms of elongate members, devices and the system described herein constitute preferred embodiments of this invention, it is to be understood that the invention is not limited to these precise forms. As will be apparent to those skilled in the art, the various embodiments described above can be combined to provide further embodiments. Aspects of the present device and system, and methods of use (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments. Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims

I claim:

1. A mobile bead breaking device, for separating a tire bead from a rim, which comprises a cylindrical body, a bead seat engaging base lock with a plurality of bead seat engaging surfaces, stepped at each surface for full paired connection with an abutting face of the bead seat band; a rim flange engaging foot, a base lock tightener and a power transmission source within the body to i) vertically slide the base lock into removable connection with the plurality of bead seat engaging surfaces and to slide the foot into engagement with the rim; ii) horizontally slide the foot to disengage the rim from the tire bead.

2. The device of claim 1 wherein the base lock tightener is a hand threaded knob.

3. The device of claim 1 wherein the power transmission source is hydraulic.

4. The device of claim 1 wherein the power transmission source is pneumatic.

5. The device of claim 1 wherein the bead seat engaging base lock is configured to slide vertically against the body.

6. The device of claim 1 wherein the rim flange engaging foot is configured to slide vertically against the body.

7. The device of claim 1 wherein the body comprises a mount for the power transmission source.

8. A method of separating a tire bead from a rim, comprising a bead seat band, which method comprises:
a) engaging a base lock of a mobile bead breaking device with a plurality of bead seat engaging surfaces, wherein the base lock is stepped at each bead seat engaging surface for full paired connection with a respective abutting face of the bead seat band;
b) engaging a foot of a mobile bead breaking device with a rim flange;
c) tightening the base locker to secure connection to each surface of the bead seat band;
d) vertically sliding the base lock into removable connection with the plurality of bead seat engaging surfaces;
e) sliding the foot into engagement with the rim; and
f) horizontally sliding the foot to disengage the rim from the tire bead.

9. The method of claim 8 wherein the base lock tightener is a hand threaded knob.

10. The method of claim 8 wherein the power transmission source is hydraulic.

11. The method of claim 8 wherein the power transmission source is pneumatic.

12. The method of claim 8 wherein the bead seat engaging base lock is configured to slide vertically against the body.

13. The method of claim 8 wherein the rim flange engaging foot is configured to slide vertically against the body.
